(19) United States
(12) Patent Application Publication
(10) Pub. No.: US 2011/0307773 A1
(43) Pub. Date: Dec. 15, 2011

(54) Systems and methods for performing project management functions in a spreadsheet application

(76) Inventors: Nenad Grmusa, Cambridge, MA (US); Dejan Mircevski, Toronto (CA)

(21) Appl. No.: 12/802,635

(22) Filed: Jun. 11, 2010

(51) Int. Cl. G06F 17/00

(52) U.S. Cl. 715/215; 715/220

(57) ABSTRACT

A system and method is provided for performing project planning functions within a spreadsheet application program.

### CROSS REFERENCE TO RELATED APPLICATIONS

This non provisional patent application is claiming the benefit of provisional patent application US 61/185,352 filed on Jun. 09, 2009.

### APPLICABLE FIELD

The field of the present invention relates generally to systems and methods for performing project management functions.

### BACKGROUND

There are many different project planning tools available for use on computer systems such as personal computer systems. Commercial examples of such project planning tools include, for example, the Microsoft Project planning tool available from the Microsoft Corporation, Redmond, Wash. Such commercial project planning tools allow users to create projects, such as work projects that require the use of one or more resources, such as personnel, materials, among others. Such tools allow users to plan projects and analyze and determine project requirements for such plans.

### SUMMARY

There are issues with using conventional project planning tools. Generally, such applications are expensive and difficult to use. Many require complex server-based systems and are not suitable for use on a personal computer system. Further, it is appreciated that there are other applications that include information that could be used in such project planning applications. However, it is difficult to link data from such external resources to such project planning tools.

According to one embodiment consistent with principles consistent with the present invention, it is appreciated that providing project planning functions within a spreadsheet application program may be beneficial. For instance, according to one embodiment, functionality may be provided that permits a spreadsheet application program to display project planning information in one or more cells of a displayed spreadsheet. Because one or more project planning functions are provided within the spreadsheet application, the project planning functions may utilize data within that particular spreadsheet without the need for data conversion and/or linking between application programs.

According to another embodiment, additional functionality is provided within a spreadsheet application as a project engine that is executed by the spreadsheet application program. The project engine is capable of accepting inputs from a user in cells of a spreadsheet application program, and to perform project functions within an interface of a spreadsheet application program. In one embodiment, parameters that describe information in relation to a task are included with in a row of the spreadsheet. In another embodiment, the project engine is capable of rendering Gantt chart information within cells of the spreadsheet application program. In one embodiment, the Gantt chart information resides within the same row as the parameters that describe the represented task. According to another embodiment, when a user resizes a range of cells containing Gantt chart information, the project engine is capable of resizing the displayed information within those cells.

According to another embodiment, the project engine may include a control that permits, for example, that enables and/or disables project planning function use within the spreadsheet application. Once enabled, the project engine may be capable of displaying within the spreadsheet a project template including a timeline that permits a user to enter tasks and their associated resources within the spreadsheet. Resources as used herein may be generally any physical or virtual entity of limited availability, including natural, human, money, tangible and intangible resources, or any other resource used to accomplish a task.

The project engine may include further controls that adjust the display behavior of the project engine and its display of data within the spreadsheet. For instance, if a user desires a different time resolution for displaying project data, a control (e.g., a popup window, dropdown menu, or other type of control) may be provided that permits the user to enter a desired resolution, and responsive to the user entering the resolution, adjust the resolution of the Gantt chart information within the spreadsheet cells.

According to another embodiment, the project engine may identify a time relation between tasks entered by a user within different cells, and responsive to that relation, the project engine may draw in the display a display of dependency information (e.g., a line drawn between blocks) to visually represent the dependency relationship within the interface. In one example implementation, the project engine may draw, within the spreadsheet interface, a rectangular object associated with a project task, and draw dependency information whenever a user enters dependency relation information between the project tasks. Tasks may also be represented in separate rows within the spreadsheet, and dependency information between tasks could be represented as a cell entry in a row that indicates a dependency relationship to another row (or task).

The project engine may also be capable of representing, with the spreadsheet interface, critical path information in relation to the project task information that is entered by the user. For instance, it is appreciated that project planning tools have the capability of representing critical path information, however, such applications are incapable of representing such information visually within a spreadsheet application. According to one embodiment, critical path tasks are indicated by a color within the Gantt chart representation of that project task.

Further features and advantages as well as the structure and operation of various embodiments are described in detail below with reference to the accompanying drawings. In the drawings, like reference numerals indicate like or functionally similar elements. Additionally, the left-most one or two digits of a reference numeral identifies the drawing in which the reference numeral first appears.

### Examples

The aspects disclosed herein, which are in accord with the present invention, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to, performing one or more project management functions within a spreadsheet application program. However, such a system may also perform other functions. Moreover, the systems described herein may be configured to include or exclude any of the functions discussed herein. Thus the invention is not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

As discussed, one embodiment relates to a computer system that includes a spreadsheet application program that could be modified for use to permit project management functions to be performed. However, it should be appreciated that a special-purpose computer system may be programmed to include one or more project management functions within a spreadsheet environment. According to one embodiment, code may be provided that performs one or more project management tasks within a spreadsheet application program. The code may perform functions of the project engine as discussed above. In the case where the spreadsheet application is a Microsoft Excel application program, the code may in the form of an add-in program that is configured to perform project management functions. The add-in program may permit the user to enter project-level data within the spreadsheet application program (e.g., the Microsoft Excel program) and to perform project management tasks (e.g., display of Gantt chart information) within the spreadsheet application program interface.

### Computer System

Various aspects and functions described herein in accord with the present invention may be implemented as hardware or software on one or more computer systems. There are many examples of computer systems currently in use that may be suitable for implementing various aspects of the present invention. Some examples include, among others, network appliances, personal computers, workstations, mainframes, networked clients, servers, media servers, application servers, database servers and web servers. Other examples of computer systems may include mobile computing devices, such as cellular phones and personal digital assistants, network equipment, devices involved in commerce such as bar code scanners and other devices. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof Thus, aspects in accord with the present invention may be implemented within methods, acts, systems, system elements and components using a variety of hardware and software configurations, and the invention is not limited to any particular distributed architecture, network, or communication protocol.

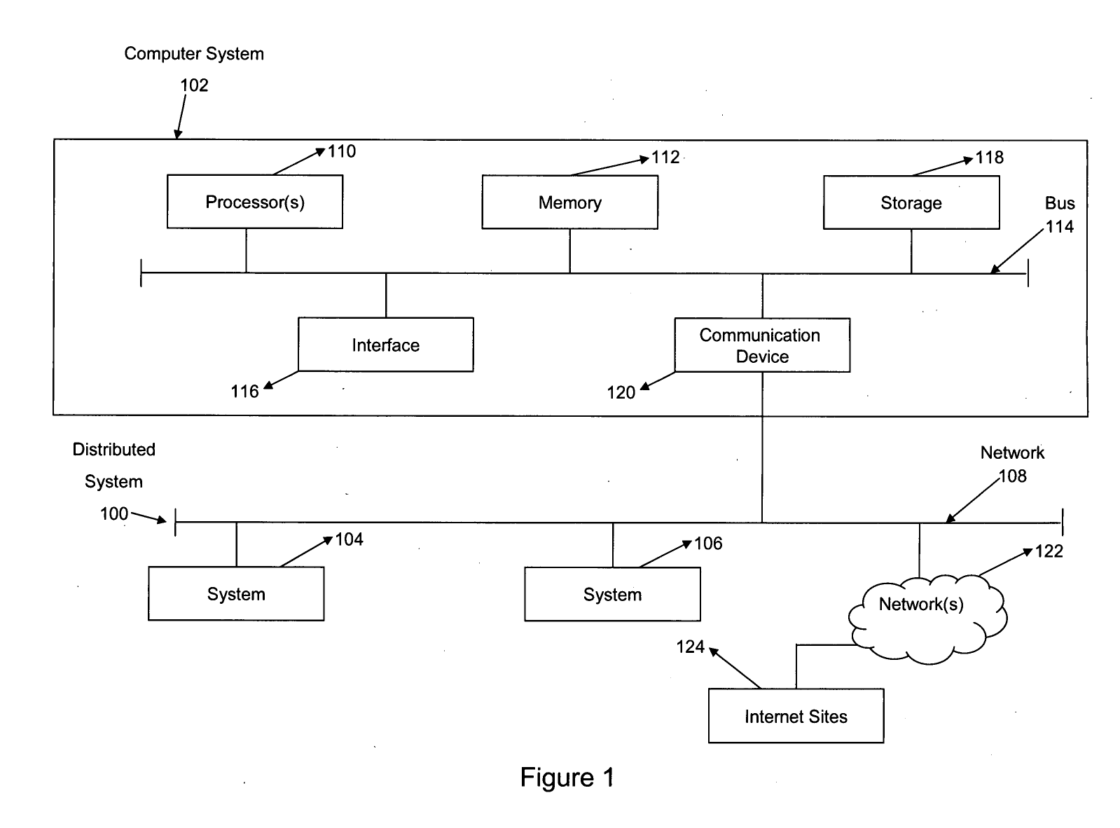

FIG. 1 shows a block diagram of a distributed computer system 100, in which various aspects and functions in accord with the present invention may be practiced. The distributed computer system 100 may include one more computer systems. For example, as illustrated, the distributed computer system 100 includes three computer systems 102, 104 and 106, but distributed computer system 100 could include any number of systems. As shown, the computer systems 102, 104 and 106 are interconnected by, and may exchange data through, a communication network 108.

Network 108 may include any communication network through which computer systems may exchange data. To exchange data via network 108, the computer systems 102, 104 and 106 and the network 108 may use various methods, protocols and standards including, among others, Ethernet, Wi-Fi, Bluetooth, TCP/IP, UDP, HTTP, FTP, SNMP, SMS, MMS, SS7, JSON, XML, REST, SOAP, RMI, DCOM and/or Web Services. To ensure data transfer is secure, the computer systems 102, 104 and 106 may transmit data via the network 108 using a variety of security measures including TSL, SSL or VPN, among other security techniques. While the distributed computer system 100 illustrates three networked computer systems, the distributed computer system 100 may include any number of computer systems, networked using any medium and communication protocol or combination thereof.

Various aspects and functions in accord with the present invention may be implemented as specialized hardware or software executing in one or more computer systems including a computer system 102 shown in FIG. 1. Optionally, various aspects of the present invention may be implemented as programs that are executed by a standalone computer system, but it should appreciated that one or more compunents may be distributed to other computer systems.

As depicted, the computer system 102 includes a processor 110, a memory 112, a bus 114 or other internal communication system, an interface 116, a storage system 118 and a communication device 120. Processor 110, which may include one or more microprocessors or other types of controllers, can perform a series of instructions that result in manipulated data. Processor 110 may be a commercially available processor such as an Intel Pentium, Motorola PowerPC, SGI MIPS, Sun UltraSPARC, or Hewlett-Packard PA-RISC processor, but may be any type of processor or controller as many other processors and controllers are available. As shown, processor 110 may be connected to other system elements, including a memory 112, by bus 114.

Memory 112 may be used for storing programs and data during operation of the computer system 102. Thus, memory 112 may be a relatively high performance, volatile, random access memory such as a dynamic random access memory (DRAM) or static memory (SRAM). However, memory 112 may include any device for storing data, such as a disk drive or other non-volatile storage device. Various embodiments in accord with the present invention can organize memory 112 into particularized and, in some cases, unique structures to perform the aspects and functions disclosed herein.

Components of computer system 102 may be coupled by an interconnection element such as bus 114. Bus 114 may include one or more physical busses (for example, busses between components that are integrated within a same machine), but may include any communication coupling between system elements including specialized or standard computing bus technologies such as IDE, SCSI, PCI and InfiniBand. Thus, bus 114 may enable communications (for example, data and instructions) to be exchanged between system components of the computer system 102.

The computer system 102 also includes one or more interface devices 116 such as input devices, output devices and combination input/output devices. Interface devices 116 may receive input or provide output. More particularly, output devices may render information for external presentation. Input devices may accept information from external sources. Examples of interface devices include, among others, keyboards, bar code scanners, mouse devices, trackballs, magnetic strip readers, microphones, touch screens, printing devices, display screens, speakers, network interface cards, etc. The interface devices 116 allow the computer system 102 to exchange information and communicate with external entities, such as users and other systems.

Storage system 118 may include a computer readable and writeable nonvolatile storage medium in which instructions are stored that define a program to be executed by the processor. Storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk or flash memory, among others. In operation, processor 110 or some other controller may cause data to be read from the nonvolatile recording medium into another memory, such as the memory 112, that allows for faster access to the information by the processor than does the storage medium included in the storage system 118. The memory may be located in storage system 118 or in memory 112. Processor 110 may manipulate the data within memory 112, and then copy the data to the medium associated with the storage system 118 after processing is completed. A variety of components may manage data movement between the medium and integrated circuit memory element and the invention is not limited thereto. Further, the invention is not limited to a particular memory system or storage system.

Although computer system 102 is shown by way of example as one type of computer system upon which various aspects and functions in accord with the present invention may be practiced, aspects of the invention are not limited to being implemented on the computer system as shown in FIG. 1. Various aspects and functions in accord with the present invention may be practiced on one or more computers having a different architectures or components than that shown in FIG. 1. For instance, computer system 102 may include specially-programmed, special-purpose hardware, such as for example, an application-specific integrated circuit (ASIC) tailored to perform a particular operation disclosed herein. While another embodiment may perform the same function using several general-purpose computing devices running MAC OS System X with Motorola PowerPC processors and several specialized computing devices running proprietary hardware and operating systems.

Computer system 102 may include an operating system that manages at least a portion of the hardware elements included in computer system 102. A processor or controller, such as processor 110, may execute an operating system which may be, among others, a Windows-based operating system (for example, Windows NT, Windows 2000 (Windows ME), Windows XP, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various aspects and functions in accord with the present invention may be implemented in a non-programmed environment (for example, documents created in HTML, XML or other format that, when viewed in a window of a browser program, render aspects of a graphical-user interface or perform other functions). Further, various embodiments in accord with the present invention may be implemented as programmed or non-programmed elements, or any combination thereof For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing commercial product, such as, for example, Database Management Systems such as SQL Server available from Microsoft of Seattle Wash., Oracle Database from Oracle of Redwood Shores, Calif., and MySQL from Sun Microsystems of Santa Clara, Calif. or integration software such as WebSphere middleware from IBM of Armonk, N.Y.

Other elements of the computer system that implements various aspects described herein may include other types of well-known systems. For instance, various embodiments may be capable of working with one or more systems or components coupled through one or more communication networks (e.g., networks 122).

### Examples

Several example features are found in the attached Appendix A, which forms an integral part of the present application and is incorporated herein in its entirety. In particular, Appendix A describes various features and examples which may be implemented either alone or in combination with other features and examples. Appendix A also describes various interface elements that may be used to implement certain functions within a spreadsheet-based interface.

It should be understood that the invention is not limited to each of the embodiments described herein, but rather, various embodiments of the invention may be practiced alone or in combination with other embodiments.

Based on the foregoing disclosure, it should be apparent to one of ordinary skill in the art that the invention is not limited to a particular computer system platform, processor, operating system, network, or communication protocol. Also, it should be apparent that the present invention is not limited to a specific architecture or programming language.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

What is claimed is:

1. A method for performing one or more functions within a spreadsheet application program, the method comprising acts of:
accepting, within a first cell of a spreadsheet presented by the spreadsheet application program, a first portion of element project task data from a user, the first portion defining a first task within a project;
accepting, within a second cell of the spreadsheet, a second portion of element project task data from the user, the second portion defining a second task within the project; and
defining, within the interface of the spreadsheet application program, a dependency relationship between the first portion and second portion, the dependency relationship identifying a dependency between the first and second tasks.

2. The method according to claim 1, further comprising an act of presenting, graphically within the interface of the spreadsheet application program, a representation of the first task of the project.

3. The method according to claim 2, further comprising an act of displaying a Gantt chart representation within the interface of the spreadsheet application program including the representation of the first task of the project.

4. The method according to claim 3, further comprising an act of displaying, graphically within the interface of the spreadsheet application program, the dependency relationship identifying the dependency between the first and second tasks.

5. The method according to claim 1, further comprising an act of adjusting, responsive to a change in time resolution from a user, a display of the first and second portions of data within the interface of the spreadsheet application program.

6. The method according to claim 1, further comprising acts of representing, in the interface of the spreadsheet application program, a Gantt chart representation of the project and adjusting, responsive to an entry of project data from a user, the Gantt chart representation.

7. The method according to claim 1, wherein the first cell of the spreadsheet exists within a first row of the spreadsheet, and wherein the first row of the spreadsheet includes information placed in one or more cells that describe the first task of the project.

8. The method according to claim 1, further comprising an act of presenting, within the interface of the spreadsheet program a control, when executed, permits the user to define a resource associated with the first task.

9. The method according to claim 8, further comprising an act of permitting the user to input, within the interface of the spreadsheet program, a total amount for the resource associated with the first task.

10. The method according to claim 8, further comprising an act of permitting the user to input, within the interface of the spreadsheet program, an average amount for the resource associated with the first task.

11. The method according to claim 9, further comprising an act of defining, responsive to the act of defining a total amount for the resource associated with the first task, a resource spread that defines a distribution of the resource over a period of the first task.

12. The method according to claim 11, wherein the resource spread is at least one of a predefined distribution and a user-defined distribution.

13. The method according to claim 8, further comprising an act of permitting the user to input, within the interface of the spreadsheet program, a multiplication factor for the resource associated with the first task, wherein the multiplication factor is multiplied by a resource amount for the resource associated with the first task.

14. The method according to claim 13, further comprising an act of permitting the user to selectively view, within the interface of the spreadsheet program, either a raw data view of the resource associated with the first task or a factored view that includes the multiplication factor multiplied by the resource amount.

15. The method according to claim 8, further comprising an act of presenting, within the interface of the spreadsheet program, a representation of a distribution of the defined resource over a period of time.

16. The method according to claim 15, further comprising an act of presenting, within the interface of the spreadsheet program, a control that, when executed, permits the user to adjust a resolution of time, and, responsive to an adjustment in resolution, modifies the representation of the distribution of the defined resource over time.

17. A system that performs one or more functions within a spreadsheet application program, the system comprising:
a component adapted to accept, within a first cell of a spreadsheet presented by the spreadsheet application program, a first portion of element project task data from a user, the first portion defining a first task within a project;
a component adapted to accept, within a second cell of the spreadsheet, a second portion of element project task data from the user, the second portion defining a second task within the project; and
a component configured to define, within the interface of the spreadsheet application program, a dependency relationship between the first portion and second portion, the dependency relationship identifying a dependency between the first and second tasks.

18. The system according to claim 17, further comprising a component adapted to present, graphically within the interface of the spreadsheet application program, a representation of the first task of the project.

19. The system according to claim 18, further comprising a component adapted to display a Gantt chart representation within the interface of the spreadsheet application program including the representation of the first task of the project.

20. The system according to claim 19, further comprising a component adapted to display, graphically within the interface of the spreadsheet application program, the dependency relationship identifying the dependency between the first and second tasks.

21. The system according to claim 17, further comprising a component adapted to adjust, responsive to a change in time resolution from a user, a display of the first and second portions of data within the interface of the spreadsheet application program.

22. The system according to claim 17, further comprising a component adapted to represent, in the interface of the spreadsheet application program, a Gantt chart representation of the project and a component adapted to adjust, responsive to an entry of project data from a user, the Gantt chart representation.

23. The system according to claim 17, wherein the first cell of the spreadsheet exists within a first row of the spreadsheet, and wherein the first row of the spreadsheet includes information placed in one or more cells that describe the first task of the project.

24. The system according to claim 17, further comprising a component adapted to present, within the interface of the spreadsheet program a control, when executed, permits the user to define a resource associated with the first task.

25. The system according to claim 24, further comprising a component adapted to permit the user to input, within the interface of the spreadsheet program, a total amount for the resource associated with the first task.

26. The system according to claim 24, further comprising a component adapted to permit the user to input, within the interface of the spreadsheet program, an average amount for the resource associated with the first task.

27. The system according to claim 25, further comprising a component adapted to define, responsive to the act of defining a total amount for the resource associated with the first task, a resource spread that defines a distribution of the resource over a period of the first task.

28. The system according to claim 27, wherein the resource spread is at least one of a predefined distribution and a user-defined distribution.

29. The system according to claim 24, further comprising a component adapted to permit the user to input, within the interface of the spreadsheet program, a multiplication factor for the resource associated with the first task, wherein the multiplication factor is multiplied by a resource amount for the resource associated with the first task.

30. The system according to claim 29, further comprising a component adapted to permit the user to selectively view, within the interface of the spreadsheet program, either a raw data view of the resource associated with the first task or a factored view that includes the multiplication factor multiplied by the resource amount.

31. The system according to claim 17, further comprising a component adapted to present, within the interface of the spreadsheet program, a representation of a distribution of the defined resource over a period of time.

32. The system according to claim 31, further comprising a component adapted to present, within the interface of the spreadsheet program, a control that, when executed, permits the user to adjust a resolution of time, and, responsive to an adjustment in resolution, modifies the representation of the distribution of the defined resource over time.
